(19) United States
(12) Patent Application Publication
(10) Pub. No.: US 2026/0113514 A1
(43) Pub. Date: Apr. 23, 2026

(54) VIDEO GENERATION METHOD, APPARATUS, READABLE MEDIUM, ELECTRONIC DEVICE AND PROGRAM PRODUCT

(71) Applicant: Beijing Youzhuju Network Technology Co., Ltd., Beijing (CN)

(72) Inventors: Xiaojie WANG, Beijing (CN); Hao LV, Beijing (CN); Shupei HE, Beijing (CN); Xiaomin SONG, Beijing (CN); Hui WANG, Beijing (CN); Kailing PAN, Beijing (CN); Yufeng GAO, Beijing (CN)

(21) Appl. No.: 19/365,908

(22) Filed: Oct. 22, 2025

(30) Foreign Application Priority Data
Oct. 22, 2024 (CN) 202411480866.7

(51) Int. Cl. H04N 21/81; H04N 21/431; H04N 21/854

(52) U.S. Cl. CPC H04N 21/816; H04N 21/4318; H04N 21/854

(57) ABSTRACT

A video generation method and apparatus, a readable medium, an electronic device and a program product. The method includes: displaying a video editing interface, where a target text is displayed in the video editing interface; displaying a storyboard list based on the target text in response to a storyboard generation operation on the video editing interface, where the storyboard list includes a plurality of storyboard cards, a storyboard picture and a storyboard subtitle obtained by splitting the target text are displayed in each of the storyboard cards; and generating a video based on the storyboard list in response to a video generation operation on the video editing interface.

### CROSS-REFERENCE TO RELATED APPLICATION

This application claims the priority to and benefits of the Chinese Patent Application, No. 202411480866.7, which was filed on Oct. 22, 2024. The aforementioned patent application is hereby incorporated by reference in its entirety.

### TECHNICAL FIELD

The present disclosure relates to the field of computer technologies, and in particular, to a video generation method and apparatus, a readable medium, an electronic device and a program product.

### BACKGROUND

With the development of computer technologies, applications can provide users with more and more abundant functions. For example, an application can provide a user with a video generation function, so that the user can generate videos by using the video generation function.

However, in the related art, when a video is generated based on the video generation function, there are problems such as complex operations and high difficulty in video generation.

### SUMMARY

The summary is provided to introduce the concepts in a simplified form that are described in detail in the following detailed description section. This summary is not intended to identify key features or essential features of the claimed technical solutions, nor is it intended to be used to limit the scope of the claimed technical solutions.

In a first aspect, the present disclosure provides a video generation method, the video generation method includes: displaying a video editing interface, where a target text is displayed in the video editing interface; displaying a storyboard list based on the target text in response to a storyboard generation operation on the video editing interface, where the storyboard list includes a plurality of storyboard cards, a storyboard picture and a storyboard subtitle are displayed in each of the storyboard cards, and the storyboard subtitle is obtained by splitting the target text; and generating a video based on the storyboard list in response to a video generation operation on the video editing interface.

In a second aspect, the present disclosure provides a video generation apparatus, the video generation apparatus includes: a first display module, configured to display a video editing interface, where a target text is displayed in the video editing interface; a second display module, configured to display a storyboard list based on the target text in response to a storyboard generation operation on the video editing interface, where the storyboard list includes a plurality of storyboard cards, a storyboard picture and a storyboard subtitle are displayed in each of the storyboard cards, and the storyboard subtitle is obtained by splitting the target text; and a generation module, configured to generate a video based on the storyboard list in response to a video generation operation on the video editing interface.

In a third aspect, the present disclosure provides a computer-readable medium, on which a computer program is stored, where the computer program, when executed by a processing apparatus, implements the steps of the method according to the first aspect.

In a fourth aspect, the present disclosure provides an electronic device, including: a storage apparatus, on which a computer program is stored; and a processing apparatus, configured to execute the computer program in the storage apparatus to implement the steps of the method according to the first aspect.

In a fifth aspect, the present disclosure provides a computer program product, including a computer program, where the computer program, when executed by a processor, implements the steps of the method according to the first aspect.

With above technical solutions, a storyboard list including storyboard cards can be generated based on a target text of a video editing interface, and a video can be generated based on the storyboard list. In this way, a video can be automatically generated based on the target text of the video editing interface, so that the complexity of the video generation operation is simplified, and the difficulty of video generation is reduced. In addition, since a storyboard card may include a storyboard picture and a storyboard subtitle, and the storyboard subtitle is obtained by splitting the target text, it is possible to intuitively show how the target text is split and quickly identify whether the storyboard image matches a picture described by the storyboard subtitle in a form of combining pictures and texts, thereby improving the accuracy and creation efficiency of video content.

Other features and advantages of the present disclosure will be described in detail in the following detailed description section.

### BRIEF DESCRIPTION OF DRAWINGS

The above and other features, advantages and aspects of embodiments of the present disclosure will become more apparent when taken in conjunction with the drawings and with reference to the following detailed description. Throughout the drawings, the same or similar reference numerals refer to the same or similar elements. It should be understood that the drawings are schematic and that parts and elements are not necessarily drawn to scale. In the drawings:

FIG. 1 is a flowchart of a video generation method according to an exemplary embodiment of the present disclosure;

FIG. 2 is a schematic diagram of generating a target text on a text editing page according to an exemplary embodiment of the present disclosure;

FIG. 3 is a schematic diagram of a storyboard list according to an exemplary embodiment of the present disclosure;

FIG. 4 is a schematic diagram of previewing a storyboard picture in a second display region according to an exemplary embodiment of the present disclosure;

FIG. 5 is a schematic diagram of displaying different display regions in a video editing interface according to an exemplary embodiment of the present disclosure;

FIG. 6 is a schematic diagram of replacing a storyboard picture in a storyboard card with a target picture generated based on a configuration panel according to an exemplary embodiment of the present disclosure; and

FIG. 7 is a schematic diagram of replacing a storyboard picture in a storyboard card with another target picture generated based on a configuration panel according to an exemplary embodiment of the present disclosure.

FIG. 8 is a schematic diagram of displaying a historical storyboard picture generated based on a configuration panel according to an exemplary embodiment of the present disclosure;

FIG. 9 is a schematic diagram of displaying a first control and a second control in a video editing interface according to an exemplary embodiment of the present disclosure;

FIG. 10 is a schematic diagram of displaying a third control and a fourth control in a video editing interface for configuring a configuration interface of an added content according to an exemplary embodiment of the present disclosure;

FIG. 11 is a schematic diagram of adding a new storyboard card before a first storyboard card based on the configuration interface according to an exemplary embodiment of the present disclosure;

FIG. 12 is a schematic diagram of displaying a first identification and a second identification in a generated video according to an exemplary embodiment of the present disclosure;

FIG. 13 is a schematic diagram of updating a storyboard picture in a storyboard card according to an exemplary embodiment of the present disclosure;

FIG. 14 is a structural block diagram of a video generation apparatus according to an exemplary embodiment of the present disclosure; and

FIG. 15 is a structural schematic diagram of an electronic device according to an exemplary embodiment of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that various steps described in method implementations of the present disclosure may be performed in different orders and/or in parallel. In addition, the method implementations may include additional steps and/or omit the steps shown. The scope of the present disclosure is not limited in this respect.

The term “include/comprise” and its variants used herein are open-ended inclusions, that is, “include/comprise but not limited to”. The term “based on” is “at least partially based on”. The term “one embodiment” means “at least one embodiment”; the term “another embodiment” means “at least one another embodiment”; and the term “some embodiments” means “at least some embodiments”. The relevant definitions of other terms will be given in the following description.

It should be noted that concepts such as “first” and “second” mentioned in the present disclosure are only used to distinguish different apparatuses, modules or units, and are not used to limit the order or interdependence of functions performed by these apparatuses, modules or units.

It should be noted that the modifiers “one” and “a plurality of” mentioned in the present disclosure are illustrative rather than restrictive, and those skilled in the art should understand that unless the context clearly indicates otherwise, they should be understood as “one or more”.

The names of messages or information exchanged between a plurality of apparatuses in the implementations of the present disclosure are only for illustrative purposes, and are not intended to limit the scope of these messages or information.

It can be understood that, before using the technical solutions disclosed in the embodiments of the present disclosure, the user should be informed of the type, use scope, use scene, etc. of the personal information involved in the present disclosure through an appropriate manner according to relevant laws and regulations, and the authorization of the user should be obtained.

For example, in response to receiving an active request from the user, prompt information is sent to the user to explicitly prompt the user that the operation the user requested to be performed will require the acquisition and use of the user's personal information. In this way, the user can choose whether to provide personal information to software or hardware such as an electronic device, an application, a server or a storage medium that performs the operation of the technical solution of the present disclosure according to the prompt information.

As an optional but non-limiting implementation, in response to receiving the active request from the user, the prompt information is sent to the user for example in a pop-up window, and the prompt information may be presented in text in the pop-up window. In addition, the pop-up window may also carry a selection control for the user to select “agree” or “disagree” to provide personal information to the electronic device.

It can be understood that above process of notifying and acquiring the user's authorization is only illustrative and does not constitute a limitation on the implementations of the present disclosure, and other methods that meet relevant laws and regulations may also be applied to the implementations of the present disclosure.

At the same time, it can be understood that the data involved in the technical solution (including but not limited to the data itself, the acquisition or use of the data) should comply with the requirements of corresponding laws, regulations and related provisions.

As mentioned in the background section, when a video is generated based on the video generation function, there are problems such as complex operations and high difficulty in video generation.

For example, in a video generation scene of a story type such as a novel, it is generally necessary to generate a video through the following steps:

Step 1: read content of a novel, understand a key plot theme in the content of the novel, and then summarize it into an overview script of about one thousand words;

Step 2: split the overview script into paragraphs or sentences, and find suitable image materials for each paragraph of text or each sentence of text, or draw corresponding image materials for each paragraph of text or each sentence of text by using a drawing tool.

Step 3: edit all image materials into a video based on a video editing tool, dub the video by using a dubbed tool, and finally synthesize the dubbing and the video to obtain an edited video.

However, in this process, the script summarizing time is generally 1-2 hours, and there is a problem of long script summarizing time; at the same time, due to the difficulty in drawing the image materials, there is a problem of homogenization of the image materials, resulting in a problem of low quality of the finally generated video. In addition, since the video editing operation is complex, for a video maker without editing experience, there are problems such as complex operations and high difficulty in video generation.

In view of this, the present disclosure provides a video generation method and apparatus, a readable medium, an electronic device and a program product to solve above technical problems.

The embodiments of the present disclosure will be further explained below with reference to the drawings.

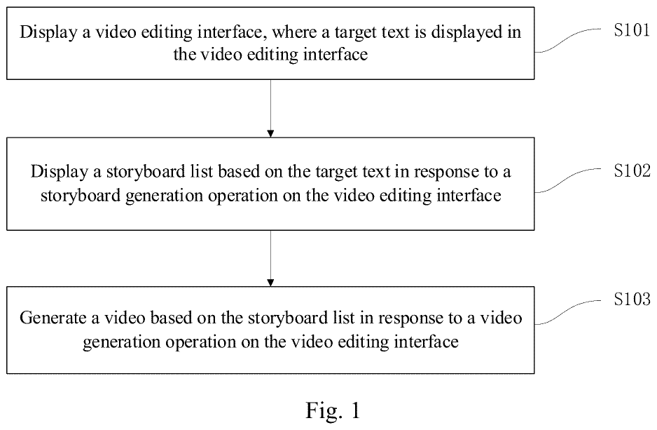

FIG. 1 is a flowchart of a video generation method according to an exemplary embodiment of the present disclosure. Referring to FIG. 1, the method may include the following steps.

S101: display a video editing interface, where a target text is displayed in the video editing interface.

In this embodiment, the target text displayed in the video editing interface may be input by the user through an external input device, such as a keyboard, a touch screen or a microphone and other input devices, or may be obtained by extracting a video text, or may be selected from a preset text script library, and of course, may also be obtained in other ways, which is not limited by the embodiments of the present disclosure.

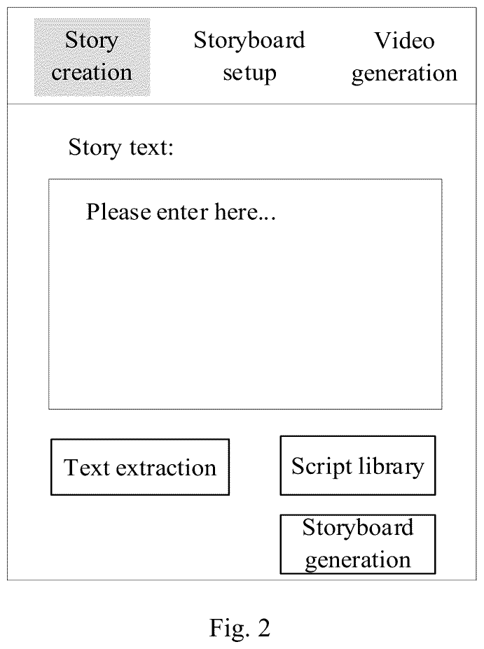

For example, when the user opens a video generation application in a terminal device, a function interface of the video generation application can be displayed, and the function interface can be displayed with a text generation control “story creation” for generating a video script. The text generation control “story creation” is triggered by a trigger operation such as clicking, long pressing or sliding, and a text editing page is displayed, as shown in FIG. 2. The text editing page may be displayed with a text input box, a text extraction control and a text script library control. When the user inputs a text in the text input box, the target text displayed in the video editing interface is obtained. When the user clicks on the text extraction control, an upload page for uploading an image, an audio or a video may be displayed. After the image, the audio or the video is uploaded on the upload page, a corresponding text may be automatically extracted from the image, the audio or the video, and may be displayed in the text input box, so that the user can adjust the text content. When the user clicks on the text script library control, a preset video script and/or a historical generated video script may be displayed, and by clicking on a target video script, the target video script may be displayed in the text input box, so that the user can adjust the text content.

After the target text is displayed in the video editing interface, the storyboard list can be generated based on the target text.

S102: display a storyboard list based on the target text in response to a storyboard generation operation on the video editing interface, where the storyboard list includes multiple storyboard cards, a storyboard picture and a storyboard subtitle are displayed in each of the storyboard cards, and the storyboard subtitle is obtained by splitting the target text.

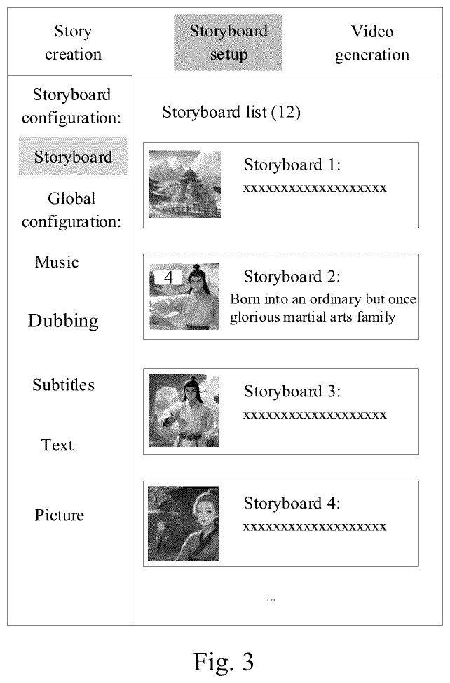

For example, reference may continue to be made to FIG. 2, and a storyboard generation control “storyboard generation” for generating a storyboard may be displayed at the bottom of the text editing page. Thus, after the target text is obtained on the text editing page, the storyboard list generated based on the target text can be obtained by clicking on the storyboard generation control “storyboard generation”, as shown in FIG. 3.

The display order of the storyboard cards in the storyboard list may be arbitrary or may be displayed in a text coherence order based on the storyboard subtitles, which is not limited by the embodiments of the present disclosure. In this embodiment, in order to facilitate the user to quickly and coherently preview the storyboard as a whole, the storyboard cards in the storyboard list can be displayed in the text coherence order based on the storyboard subtitles, so that the storyboard cards have a chronological order relationship, so that when the video is generated subsequently, the video can be generated based on the display order of the storyboard cards in the storyboard list.

In this embodiment, the storyboard picture in the storyboard card may be a static picture or a dynamic picture, and the storyboard picture associated with the storyboard card may include one or more storyboard pictures, which is not limited by the embodiments of the present disclosure. When the storyboard card is associated with a plurality of storyboard pictures, any one of the storyboard pictures may be displayed in the storyboard card, and the number of associated storyboard pictures may be displayed in the storyboard picture displayed in the storyboard card, as shown in FIG. 3.

In a possible way, in order to quickly and uniformly configure all storyboard cards or configure other contents of the to-be-generated video, it is also possible to preset areas around the storyboard list. For example, function controls for configuring different contents may be displayed in a left display area of the storyboard list. For example, a music control for configuring background music may be displayed, a subtitle control for configuring a subtitle style may be displayed, and/or a dubbed control for configuring audio may be displayed, as shown in FIG. 3.

S103: generate a video based on the storyboard list in response to a video generation operation on the video editing interface.

For example, a video generation control for generating a video may be displayed on a video function interface. Thus, after the storyboard list is displayed on the video editing interface, the video may be generated based on the display order of the storyboard cards in the storyboard list by clicking on the video generation control.

With above technical solutions, the storyboard list including the storyboard cards can be generated based on the target text of the video editing interface, and the video can be generated based on the storyboard list. In this way, the video can be automatically generated based on the target text of the video editing interface, so that the complexity of the video generation operation is simplified, and the difficulty of video generation is reduced. In addition, since the storyboard card may include the storyboard picture and the storyboard subtitle, and the storyboard subtitle is obtained by splitting the target text, it is possible to intuitively show how the target text is split and quickly identify whether the storyboard image matches the picture described by the storyboard subtitle in the form of combining pictures and texts, thereby improving the accuracy and creation efficiency of video content.

In order to facilitate understanding of the video generation method provided by the present disclosure, possible implementations in the present disclosure will be described below.

In a possible way, the storyboard pictures in the storyboard list are displayed in a first display style, and the storyboard subtitles are displayed on a side of the storyboard pictures. Correspondingly, the video generation method may further include:
displaying a storyboard picture corresponding to a first storyboard card in the storyboard list in a second display style in the video editing interface and displaying the storyboard subtitle on the storyboard picture in response to a trigger operation on the first storyboard card, where a size of the second display style is larger than that of the first display style.

In this embodiment, the trigger operation may be a sliding operation, a click operation, or a long press operation, which is not limited by the embodiments of the present disclosure.

In this embodiment, since the size of the second display style is larger than that of the first display style, it is possible to view picture details in the storyboard picture in combination with the storyboard subtitle in the video editing interface, so that the storyboard picture matches the storyboard subtitle, thereby improving the video quality.

In a possible way, displaying the storyboard list based on the target text in response to the storyboard generation operation on the video editing interface may include:
displaying the storyboard list in a first display region of the video editing interface based on the target text in response to the storyboard generation operation on the video editing interface; and
correspondingly, the video generation method may further include:
enlarging and displaying a storyboard picture corresponding to a first storyboard card in the storyboard list in a second display region of the video editing interface and displaying the storyboard subtitle on the storyboard picture in response to a trigger operation on the first storyboard card.

In this embodiment, a size of the storyboard subtitle in the second display region may be the same as or different from a size of the storyboard subtitle in the first storyboard card, which is not limited by the embodiments of the present disclosure. In a possible way, in order to match the size of the storyboard subtitle in the second display region with a size of the storyboard picture enlargedly displayed in the second display region, the size of the storyboard subtitle in the second display region may be made larger than the size of the storyboard subtitle in the first storyboard card.

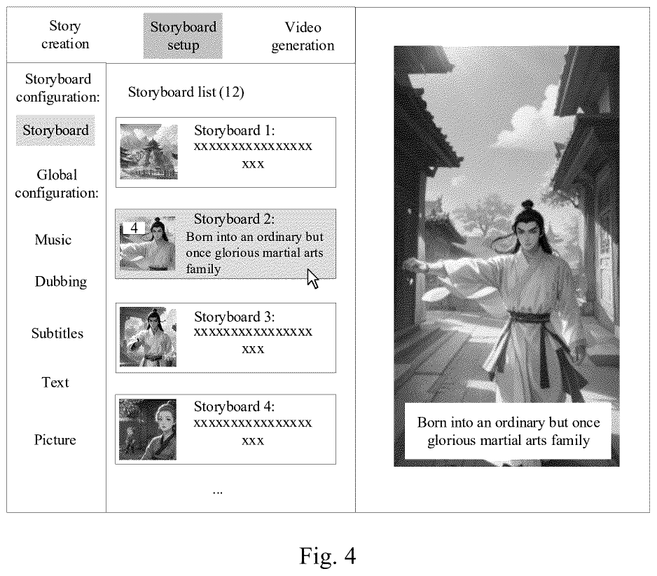

For example, continuing to refer to the above example, after the target text is obtained on the text editing page, the storyboard list may be displayed in a left display area of the video editing interface by clicking on the storyboard generation control “storyboard generation”. When any one of the storyboard cards in the storyboard list is triggered by an operation such as clicking or sliding, for example, when a second storyboard card in the storyboard list is clicked, a storyboard picture corresponding to the second storyboard card may be enlargedly displayed in a right display area of the video editing interface, and an enlarged storyboard subtitle may be displayed on the storyboard picture, as shown in FIG. 4.

In above manner, after the storyboard card is triggered, the storyboard subtitle and the storyboard picture in the storyboard card may be displayed in a preview region (that is, the second display region) of the video editing interface, so that the user can simultaneously preview the storyboard picture and the storyboard subtitle in the storyboard list and the storyboard card without switching pages, and can quickly adjust and optimize the storyboard picture and/or the storyboard subtitle in the storyboard card according to a preview result, thereby improving the efficiency of video production and the user experience.

In a possible way, the video generation method may further include:
displaying a configuration panel for configuring a storyboard picture in a third display region of the video editing interface in response to a trigger operation on a first storyboard card in the storyboard list, where the first display region, the second display region and the third display region are arranged side by side or in parallel; determining a generated target picture in response to a picture generation operation on the configuration panel, and displaying the target picture at a first preset position around the storyboard picture in the second display region; and updating and displaying the storyboard picture in the first storyboard card in the first display region as the target picture and updating and displaying the storyboard picture displayed in the second display region as the target picture in response to a selection operation on the target picture.

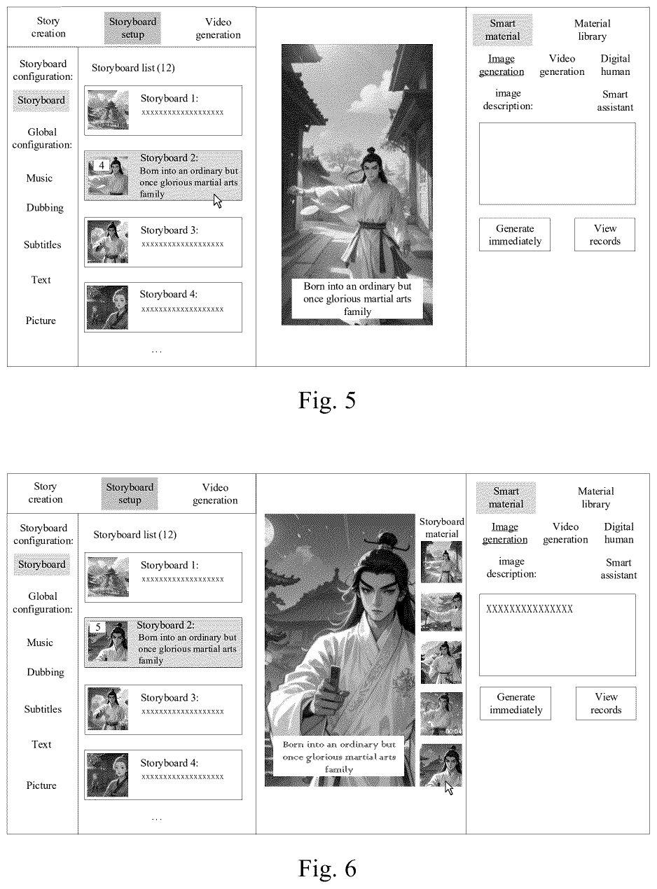

For example, continuing to refer to the above example, after the target text is obtained on the text editing page, the storyboard list may be displayed in the left display area of the video editing interface by clicking on the storyboard generation control “storyboard generation”. When any one of the storyboard cards in the storyboard list is triggered by an operation such as clicking or sliding, for example, when the second storyboard card in the storyboard list is clicked, the storyboard picture displayed in the second storyboard card may be enlargedly displayed in the middle display area of the video editing interface, and the configuration panel for configuring the storyboard picture may be displayed in the right display area of the video editing interface, as shown in FIG. 5. After the target picture is generated based on the configuration panel, the target picture may be displayed at a preset position in the second display region, for example, in a right region of the second display region. When the target picture is clicked, the storyboard picture in the first storyboard card can be updated and displayed as the target picture, and the storyboard picture displayed in the second display region can be updated and displayed as the target picture, as shown in FIG. 6.

In this embodiment, when the target picture is generated based on the configuration panel, a picture generation control for picture generation may be provided in the configuration panel, so that the target picture can be generated by triggering the picture generation control, or a material library control for acquiring pictures locally may be provided in the configuration panel.

For example, as shown in FIG. 6, the configuration panel may be provided with a picture generation control “intelligent material” and a material library control “material library”. By clicking on the picture generation control “intelligent material”, a material generation panel may be displayed, and the material generation panel may be displayed with a text input box. By inputting a keyword for generating picture content or a description text of the picture content in the text input box, a corresponding picture is generated, and the target picture is displayed at the preset position in the second display region. Alternatively, as shown in FIG. 7, by clicking on the material library control “material library”, a material list and an upload control for uploading materials may be displayed. The material list may display a plurality of pictures previously uploaded by the user, and the target picture is obtained by clicking on a picture, and the target picture is displayed at the preset position in the second display region. By clicking on the target picture displayed at the preset position, the storyboard picture in the first storyboard card can be updated and displayed as the target picture, and the storyboard picture displayed in the second display region can be updated and displayed as the target picture. Alternatively, the upload control may be clicked to display an upload page for the user to upload a new material, and after the user uploads the target picture on the upload page, the target picture is obtained.

In a possible way, in order to improve the quality of the generated picture, when the picture is generated based on the picture generation control, an intelligent assistant may also be displayed at a preset position around the text input box, so as to optimize the text input in the text input box through the intelligent assistant, or generate a keyword of the picture content or a description text of the picture content, or the like. Alternatively, an operating lever may also be provided in the configuration panel, so as to realize a more precise and complex picture parameter adjustment operation through the operating lever, so as to make a more precise adjustment to the picture, and further match the picture content with the storyboard subtitle.

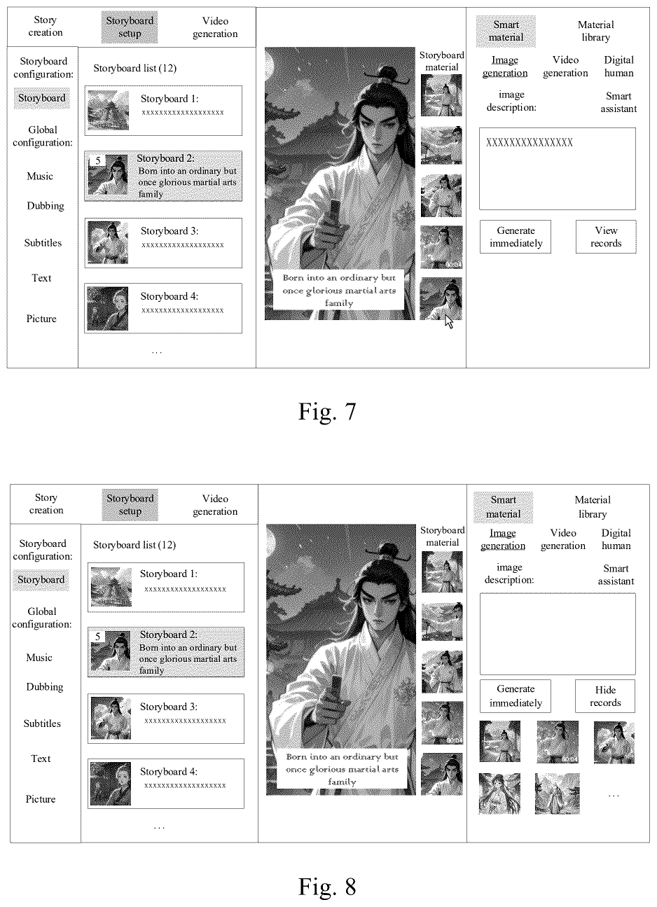

In a possible way, in order to further enrich the video content and improve the user experience, the material generation panel may also be provided with a video generation control and a digital human generation control, as shown in FIG. 8, where the video generation control may be used to generate a video, and the digital human generation control may be used to generate a digital human, so that when the generated video includes the digital human, the digital human may interact with a video viewing user, where “video generation” in FIG. 8 represents the video generation control, and “digital human” represents the digital human generation control.

In a possible way, in order to avoid repeated generation of the generated materials, the material generation panel may also be provided with a viewing control for viewing a historical generation record, as shown in FIG. 6. When the viewing control is triggered by a sliding or clicking operation, the picture generated before may be displayed in the material generation panel, and the display style of the viewing control is changed, as shown in FIG. 8. Wherein, “viewing record” in FIG. 6 represents the viewing control, and “collecting record”in FIG. 8 represents the viewing control after the display style is changed.

In this embodiment, since the first display region is used to display the storyboard list, the user can quickly view the storyboard content in the storyboard card in the first display region, so as to quickly and intuitively understand how the target text is split and whether the generated storyboard picture conforms to the scene described by the storyboard subtitle. Since the second display region can be used to quickly preview the content in the storyboard card, the user can quickly view whether the storyboard content in each storyboard card meets the user's expectation in the second display region. Since the third display region can be used for picture generation, the user can re-generate the storyboard picture in the third display region to adjust the storyboard picture in the storyboard card when the storyboard picture in the storyboard card does not meet the user's expectation. In this way, by displaying the first display region, the second display region and the third display region side by side or in parallel in the video editing interface, the user can view and adjust the generated storyboard from the shallower to the deeper, so as to meet the use of users with different experiences or operation requirements, and further improve the user experience.

In a possible way, the video editing interface is further displayed with a first control and/or a second control, the first control is used to trigger an overall preview of all storyboards in the storyboard list, and the second control is used to turn on a dynamic picture effect of a storyboard picture. Correspondingly, the video generation method may further include:
displaying preview effects of storyboards in the storyboard list in sequence according to a storyboard sequence in the storyboard list in response to a trigger operation on the first control; and/or enlarging and displaying a storyboard picture corresponding to a first storyboard card in the storyboard list in the video editing interface in response to a trigger operation on the first storyboard card in the storyboard list, and displaying a dynamic picture effect of the storyboard picture corresponding to the first storyboard card in response to a trigger operation on the second control.

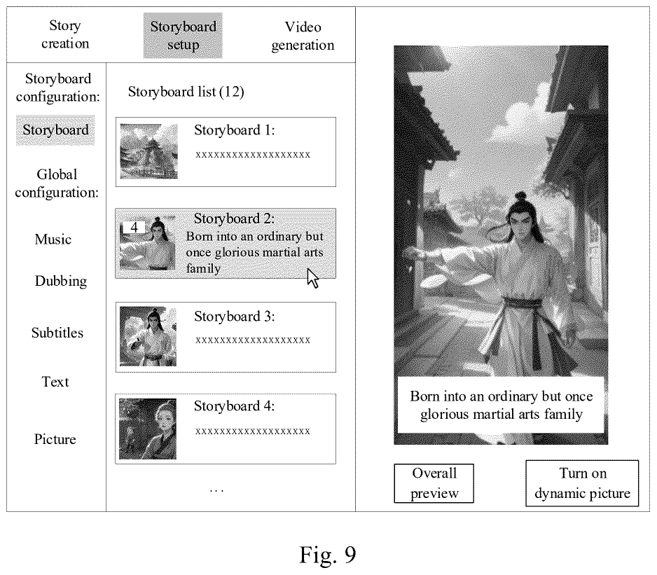

In this embodiment, the arrangement position of the first control and/or the second control may be determined according to actual conditions, which is not limited by the embodiments of the present disclosure. For example, the first control may be arranged at a top of a region where the storyboard list is located, and the second control may be arranged at a lower side of the storyboard picture displayed in the second display region. Alternatively, both the first control and the second control may be arranged at the lower side of the storyboard picture displayed in the second display region, as shown in FIG. 9, where “overall preview” in the figure represents the first control, and “turn on dynamic picture” in the figure represents the second control.

As mentioned above, the storyboard picture in the storyboard card may be a dynamic picture or a static picture. Therefore, by setting the first control, it is possible to realize dynamic and static switching of the dynamic picture, that is, when the first control is turned on, the dynamic effect of the storyboard picture can be previewed. By setting the second control, after the storyboard picture in the storyboard card is adjusted, the overall display effect can be quickly previewed.

In a possible way, in order to allow the user to more intuitively feel the synthesis logic of the video, when the second control is clicked for the overall preview, the storyboard cards in the storyboard list may be selected or highlighted in sequence according to the playing order.

In a possible way, the video generation method may further include:
displaying a third control and/or a fourth control in the video editing interface, where the third control is used to add content before all storyboards, and the fourth control is used to add content after all storyboards; and
positioning and displaying the storyboard list to a first storyboard card and simultaneously displaying a first configuration interface for configuring the content to be added in response to a trigger operation on the third control, and displaying a new storyboard card before the first storyboard card in the storyboard list in response to a content configuration operation on the first configuration interface; and/or positioning and displaying the storyboard list to a last storyboard card and simultaneously displaying a second configuration interface for configuring the content to be added in response to a trigger operation on the fourth control, and displaying a new storyboard card after the last storyboard card in response to a content configuration operation on the second configuration interface.

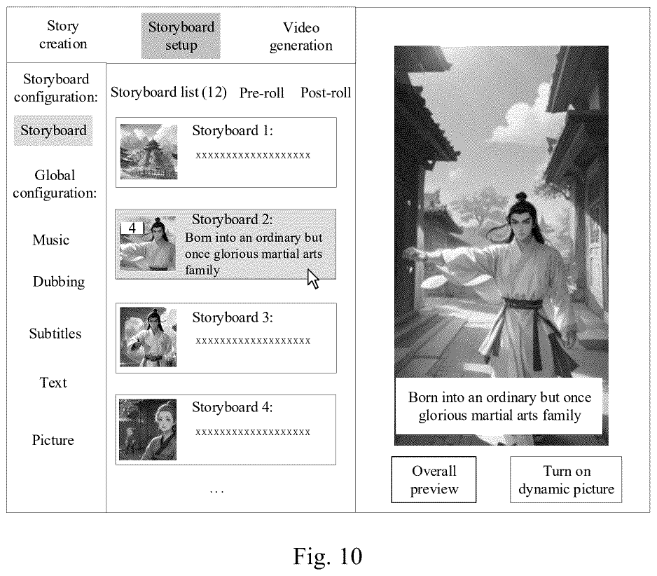

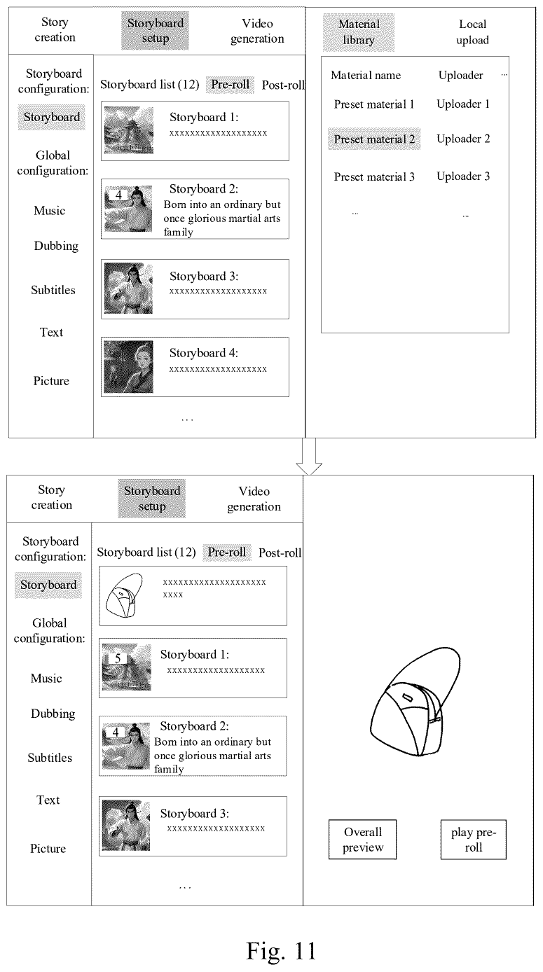

For example, the storyboard list may be displayed in the left display area of the video editing interface, and a third control “pre-roll” and a fourth control “post-roll” may be displayed at the top of the storyboard list, as shown in FIG. 10. By clicking on the third control “pre-roll”, the storyboard list may be positioned and displayed to the first storyboard card, and the first configuration interface for configuring the content to be added may be displayed in the right display area of the video editing interface. At the same time, in order to facilitate quick previewing of the added target preset material, after the target preset material is clicked, the first configuration interface displayed in the right display area may be closed, and the target preset material may be enlargedly displayed in the right display area, as shown in FIG. 11. In addition, when the target preset material is a video or a dynamic picture, a playing control “play pre-roll” may also be displayed around the target preset material, for example, at the bottom of the target preset material, so as to play the target preset material or preview the dynamic picture effect of the target preset material, as shown in FIG. 11. The first configuration interface may be displayed with a fifth control “material library” for acquiring material content from a material library and a sixth control “local upload” for the user to upload materials produced from other applications. By clicking on the fifth control “material library”, a first material list may be displayed, the first material list may display a plurality of preset materials, and by clicking on a target preset material in the first material list, a storyboard card including the selected target preset material may be displayed before the first storyboard card, so that the newly added storyboard card and the existing storyboard card are merged into a storyboard list, as shown in FIG. 11. By clicking on the sixth control, a second material list and an upload control for uploading materials may be displayed. The second material list may display a plurality of historical materials, that is, materials previously uploaded by the user. By clicking on a target historical material in the second material list, a new storyboard card may be displayed before the first storyboard card, and the selected target historical material may be included in the new storyboard card. Alternatively, the upload control may be clicked to display an upload page for the user to upload a new material. After the user uploads the target material on the upload page, on the one hand, the target material may be displayed in the second material list, and on the other hand, the new storyboard card may be displayed before the first storyboard card, and the uploaded target material may be included in the new storyboard card.

In this embodiment, the manner of displaying the new storyboard card after the last storyboard card by triggering the fourth control may refer to the manner of displaying the new storyboard card before the first storyboard card by triggering the third control, which will not be repeated here.

In this embodiment, the content to be added may be content related to the to-be-generated video, such as a video content introduction or a video content summary, or may be content not related to the to-be-generated video, such as an introduction to a product, and of course, may also be other content, which is not limited by the embodiments of the present disclosure.

In a possible way, in order to facilitate the user to intuitively feel that the content to be added has been added before the first storyboard card, after the content to be added is added before the first storyboard card by triggering the third control, a state of the third control may be changed, for example, a display state of the third control may be changed, or the third control may be made in a state that cannot be triggered. Similarly, after the content to be added is added after the last storyboard card by triggering the fourth control, a state of the fourth control may be changed, for example, a display state of the fourth control may be changed, or the fourth control may be made in a state that cannot be triggered.

In a possible way, in order to facilitate the user to quickly view the content added through the third control and/or the fourth control, after the content is added through the third control and/or the fourth control, if the third control and/or the fourth control are triggered again, the content added through the third control and/or the fourth control can be quickly located.

In above manner, the first storyboard card of the storyboard list can be quickly located through the third control, and the last storyboard card of the storyboard list can be quickly located through the fourth control. In this way, the content can be quickly added to the storyboard list, and the complexity of the user operation can be simplified. In addition, since the storyboard cards have a chronological order relationship, by triggering the third control and/or the fourth control, the content can be quickly added in chronological order, so that the integrity and rationality of the timeline can be maintained in a simple and understandable form.

In a possible way, the second storyboard card in the storyboard list is associated with a plurality of storyboard pictures, and the first storyboard picture selected by the user from the plurality of storyboard pictures is displayed in the second storyboard card. Correspondingly, generating the video based on the storyboard list in response to the video generation operation on the video editing interface may include:
generating a first video based on the first storyboard picture and a storyboard picture associated with a third storyboard card and generating a second video based on a second storyboard picture and a storyboard picture associated with the third storyboard card respectively in response to the video generation operation on the video editing interface, where the second storyboard picture is a storyboard picture in the plurality of storyboard pictures except the first storyboard picture, and the third storyboard card is a storyboard card in the storyboard list except the second storyboard card.

For example, two storyboard cards are displayed in the storyboard list, where the first storyboard card is associated with three storyboard pictures, which are denoted as storyboard picture 1, storyboard picture 2 and storyboard picture 3, and storyboard picture 1 is displayed in the first storyboard card. The second storyboard card is associated with two storyboard pictures, which are denoted as storyboard picture 4 and storyboard picture 5, and storyboard picture 5 is displayed in the second storyboard card. Therefore, when the video generation operation is triggered in the video editing interface, the first video may be generated based on storyboard picture 1 and storyboard picture 5, and the second videos may be generated based on storyboard picture 2 and storyboard picture 4, based on storyboard picture 2 and storyboard picture 5, based on storyboard picture 3 and storyboard picture 4, and based on storyboard picture 3 and storyboard picture 5, respectively.

In above manner, on the one hand, the first video may be generated based on the storyboard picture selected by the user (that is, the storyboard picture displayed in the storyboard list), and on the other hand, a plurality of second videos may be generated based on candidate storyboard pictures (that is, the storyboard pictures associated with the storyboard card except the storyboard picture displayed in the storyboard card). On the one hand, it can provide users with diversified choices of video content and avoid the influence of image material homogenization on video quality. On the other hand, by comparing video effects of different versions, the quality of video creation can be further optimized and improved.

In a possible way, the first video is displayed with a first identification, and the second video is displayed with a second identification, where the first identification is used to indicate that the first video is generated by the first storyboard picture selected by the user, and the second identification is used to indicate video feature information of the second video.

In this embodiment, the video feature information of the second video may be determined according to actual conditions, which is not limited in the embodiments of the present disclosure.

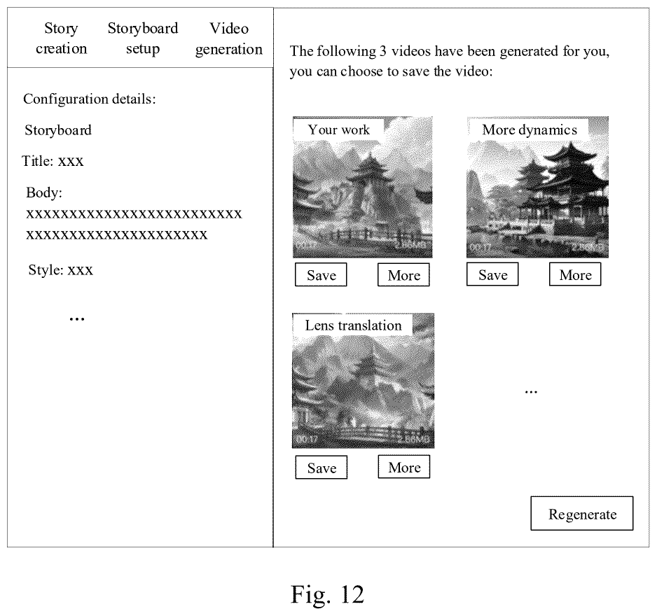

For example, as shown in FIG. 12, a first identification “your work” may be displayed on a video cover of the first video to indicate that the video is generated by the first storyboard picture selected by the user, that is, the video is generated according to the storyboard picture displayed in the storyboard card. A second identification “more dynamics” may be displayed on a video cover of the second video to indicate that the video is generated by more dynamic storyboard pictures. A second identification “lens translation” may be displayed on a video cover of the third video to indicate that the video is a video shot by a lens translation shooting technique.

In a possible way, in order to facilitate the user to adjust the generated video content, after the generated video is obtained, a seventh control for regenerating the video may also be displayed on the video editing interface. Thus, by triggering the seventh control, it is possible to jump back to the text editing page or the storyboard list display page.

In a possible way, the video generation method may further include:
enlarging and displaying a first storyboard picture in the video editing interface and displaying a plurality of storyboard pictures associated with a second storyboard card at a preset position around the first storyboard picture that is enlargedly displayed in response to a trigger operation on the second storyboard card in the storyboard list; and updating and displaying the first storyboard picture displayed in the second storyboard card as a third storyboard picture and updating and displaying the first storyboard picture that is enlargedly displayed as the third storyboard picture that is enlargedly displayed in response to a selection operation on the third storyboard picture in the plurality of storyboard pictures.

In this embodiment, the preset position around the first storyboard picture may be a position of a right display area of the first storyboard picture, or a position of a bottom display area of the first storyboard picture, and of course, may also be other display area positions, which is not limited by the embodiments of the present disclosure.

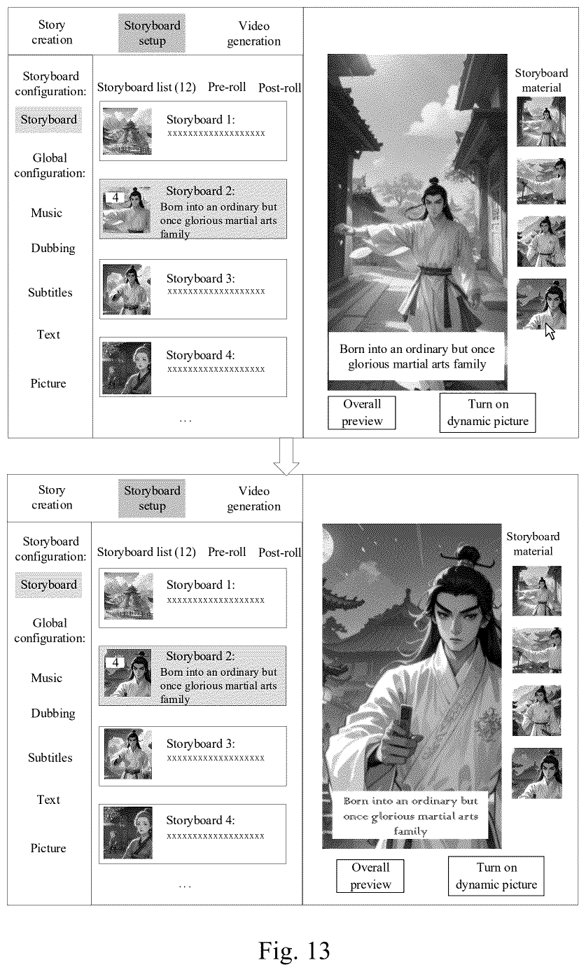

For example, as shown in FIG. 13, a storyboard list is displayed in a left display area of the video editing interface. The second storyboard card in the storyboard list is associated with four storyboard pictures, which are denoted as storyboard picture 1, storyboard picture 2, storyboard picture 3 and storyboard picture 4, where the storyboard picture displayed in the second storyboard card is storyboard picture 1. Therefore, when the second storyboard card in the storyboard list is triggered by an operation such as clicking or sliding, storyboard picture 1 may be enlargedly displayed in a right display area of the video editing interface, and storyboard picture 1, storyboard picture 2, storyboard picture 3 and storyboard picture 4 may be displayed in the right display area of the storyboard picture 1 that is enlargedly displayed. When storyboard picture 4 is clicked, storyboard picture 1 displayed in the second storyboard card may be updated and displayed as storyboard picture 4, and storyboard picture 1 enlargedly displayed in the right display area of the video editing interface may be updated and displayed as storyboard picture 4.

In a possible way, in order to facilitate the user to intuitively feel which one of the plurality of associated storyboard pictures the storyboard picture displayed in the storyboard card and the preview region (that is, the region where the first storyboard picture is enlargedly displayed) is, when the plurality of associated storyboard pictures are displayed in the preview region, the storyboard pictures displayed in the storyboard card and the preview region may be marked among the plurality of associated storyboard pictures. For example, an identification of “currently selected” or other identification information may be added to the storyboard picture.

In above manner, when the storyboard picture displayed in the storyboard card is previewed, all storyboard pictures associated with the storyboard card can be displayed at the preset position around the preview region, so that all storyboard pictures associated with the storyboard card are close to the preview region, so that when the user needs to switch the storyboard card and the storyboard picture in the preview region, all storyboard pictures associated with the storyboard card can be quickly found in the video editing interface, so that the storyboard picture in the storyboard card and the preview region can be quickly switched, thereby improving the efficiency of video generation and the user experience.

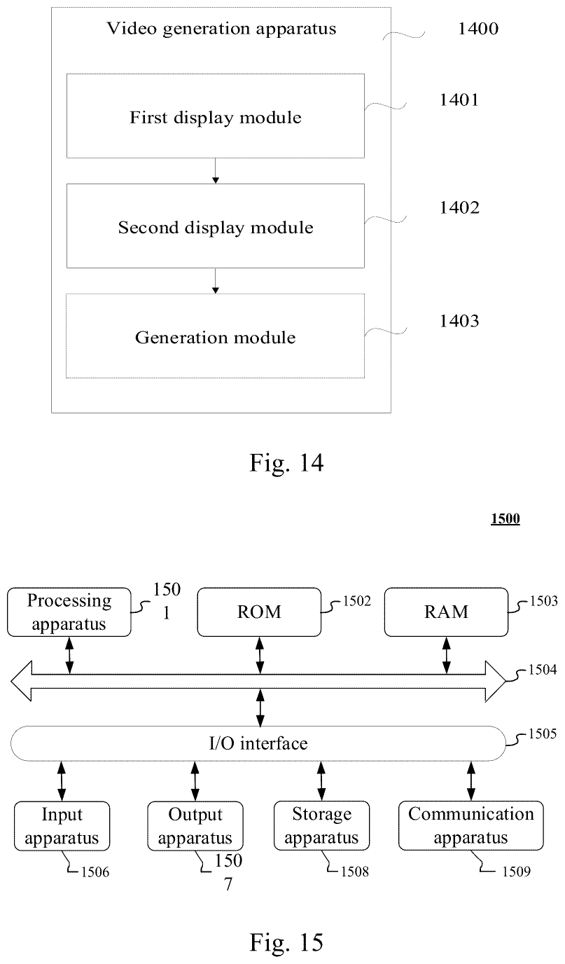

Based on the same concept, an embodiment of the present disclosure further provides a video generation apparatus. As shown in FIG. 14, the video generation apparatus 1400 may include:
a first display module 1401, configured to display a video editing interface, where a target text is displayed in the video editing interface;
a second display module 1402, configured to display a storyboard list based on the target text in response to a storyboard generation operation on the video editing interface, where the storyboard list includes a plurality of storyboard cards, a storyboard picture and a storyboard subtitle are displayed in each of the storyboard cards, and the storyboard subtitle is obtained by splitting the target text; and
a generation module 1403, configured to generate a video based on the storyboard list in response to a video generation operation on the video editing interface.

With above video generation apparatus 1400, the storyboard list including the storyboard cards can be generated based on the target text of the video editing interface, and the video can be generated based on the storyboard list. In this way, the video can be automatically generated based on the target text of the video editing interface, so that the complexity of the video generation operation is simplified, and the difficulty of video generation is reduced. In addition, since the storyboard card may include the storyboard picture and the storyboard subtitle, and the storyboard subtitle is obtained by splitting the target text, it is possible to intuitively show how the target text is split and quickly identify whether the storyboard image matches the picture described by the storyboard subtitle in the form of combining pictures and texts, thereby improving the accuracy and creation efficiency of video content.

In a possible way, the second display module 1402 may be configured to display the storyboard list in a first display region of the video editing interface based on the target text in response to the storyboard generation operation on the video editing interface.

Correspondingly, the video generation apparatus 1400 may further include:
a third display module, configured to enlarge and display a storyboard picture corresponding to a first storyboard card in the storyboard list in a second display region of the video editing interface and display the storyboard subtitle on the storyboard picture in response to a trigger operation on the first storyboard card.

In a possible way, the video generation apparatus 1400 may further include:
a fourth display module, configured to display a configuration panel for configuring a storyboard picture in a third display region of the video editing interface in response to a trigger operation on a first storyboard card in the storyboard list, where the first display region, the second display region and the third display region are arranged side by side or in parallel;
a fifth display module, configured to determine a generated target picture in response to a picture generation operation on the configuration panel, and display the target picture at a first preset position around the storyboard picture in the second display region; and
a sixth display module, configured to update and display the storyboard picture in the first storyboard card in the first display region as the target picture and update and display the storyboard picture displayed in the second display region as the target picture in response to a selection operation on the target picture.

In a possible way, the video editing interface is further displayed with a first control and/or a second control, the first control is used to trigger an overall preview of all storyboards in the storyboard list, and the second control is used to turn on a dynamic picture effect of a storyboard picture. Correspondingly, the video generation apparatus 1400 may further include:
a seventh display module, configured to display preview effects of storyboards in the storyboard list in sequence according to a storyboard sequence in the storyboard list in response to a trigger operation on the first control; and/or
an eighth display module, configured to enlarge and display a storyboard picture corresponding to a first storyboard card in the storyboard list in the video editing interface in response to a trigger operation on the first storyboard card in the storyboard list, and display a dynamic picture effect of the storyboard picture corresponding to the first storyboard card in response to a trigger operation on the second control.

In a possible way, the video generation apparatus 1400 may further include:
a ninth display module, configured to display a third control and/or a fourth control in the video editing interface, where the third control is used to add content before all storyboards, and the fourth control is used to add content after all storyboards;
a tenth display module, configured to position and display the storyboard list to a first storyboard card and simultaneously display a first configuration interface for configuring the content to be added in response to a trigger operation on the third control, and display a new storyboard card before the first storyboard card in the storyboard list in response to a content configuration operation on the first configuration interface; and/or
an eleventh display module, configured to position and display the storyboard list to a last storyboard card and simultaneously display a second configuration interface for configuring the content to be added in response to a trigger operation on the fourth control, and display a new storyboard card after the last storyboard card in response to a content configuration operation on the second configuration interface.

In a possible way, the second storyboard card in the storyboard list is associated with a plurality of storyboard pictures, and a first storyboard picture selected by a user from the plurality of storyboard pictures is displayed in the second storyboard card. Correspondingly, the generation module 1403 may be configured to generate a first video based on the first storyboard picture and a storyboard picture associated with a third storyboard card and generate a second video based on a second storyboard picture and a storyboard picture associated with the third storyboard card respectively in response to the video generation operation on the video editing interface, where the second storyboard picture is a storyboard picture in the plurality of storyboard pictures except the first storyboard picture, and the third storyboard card is a storyboard card in the storyboard list except the second storyboard card.

In a possible way, the first video is displayed with the first identification, and the second video is displayed with the second identification, where the first identification is used to indicate that the first video is generated by the first storyboard picture selected by the user, and the second identification is used to indicate the video feature information of the second video.

In a possible way, the video generation apparatus 1400 may further include:
a twelfth display module, configured to enlarge and display the first storyboard picture in the video editing interface and display plurality of storyboard pictures associated with the second storyboard card at the preset position around the first storyboard picture that is enlargedly displayed in response to the trigger operation on the second storyboard card in the storyboard list; and
a thirteenth display module, configured to update the first storyboard picture displayed in the second storyboard card as a third storyboard picture and update the first storyboard picture that is enlargedly displayed as a third storyboard picture that is enlargedly displayed in response to the selection operation on the third storyboard picture in the plurality of storyboard pictures.

Based on the same concept, an embodiment of the present disclosure further provides a computer-readable medium, on which a computer program is stored, and the program, when executed by a processing apparatus, implements the steps of any one of above video generation methods.

Based on the same concept, an embodiment of the present disclosure further provides an electronic device, which may include:
a storage apparatus, on which a computer program is stored; and
a processing apparatus, configured to execute the computer program in the storage apparatus to implement the steps of any one of above video generation methods.

Based on the same concept, an embodiment of the present disclosure further provides a computer program product, including a computer program, where the computer program, when executed by a processor, implements the steps of any one of above video generation methods.

Reference is made to FIG. 15 below, which illustrates a structural schematic diagram of an electronic device 1500 suitable for implementing the embodiments of the present disclosure. The terminal device in the embodiment of the present disclosure may include, but is not limited to, a mobile terminal such as a mobile phone, a laptop, a digital broadcast receiver, a personal digital assistant (PDA), a tablet computer, a portable multimedia player (PMP), a vehicle-mounted terminal (such as a vehicle navigation terminal), and a fixed terminal such as a digital TV, a desktop computer, etc. The electronic device shown in FIG. 15 is only an example, and should not impose any limitation on the function and scope of use of the embodiments of the present disclosure.

As shown in FIG. 15, the electronic device 1500 may include a processing apparatus (such as a central processing unit, a graphics processor, etc.) 1501, which may perform various appropriate actions and processing according to a program stored in a read-only memory (ROM) 1502 or a program loaded from the storage apparatus 1508 into a random access memory (RAM) 1503. The RAM 1503 further stores various programs and data required for the operation of the electronic device 1500. The processing apparatus 1501, the ROM 1502 and the RAM 1503 are connected with each other through a bus 1504. An input/output (I/O) interface 1505 is also connected to the bus 1504.

Generally, the following apparatuses may be connected to the I/O interface 1505: an input apparatus 1506 including, for example, a touch screen, a touch pad, a keyboard, a mouse, a camera, a microphone, an accelerometer, a gyroscope, etc. ; an output apparatus 1507 including, for example, a liquid crystal display (LCD), a speaker, a vibrator, etc. ; a storage apparatus 1508 including, for example, a magnetic tape, a hard disk, etc. ; and a communication apparatus 1509. The communication apparatus 1509 may allow the electronic device 1500 to perform wireless or wired communication with other devices to exchange data. Although FIG. 15 shows the electronic device 1500 having various apparatuses, it should be understood that it is not required to implement or have all of the illustrated apparatuses. Alternatively, more or fewer apparatuses may be implemented or provided.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program includes program codes for executing the methods shown in the flowcharts. In such an embodiment, the computer program may be downloaded and installed from a network through the communication apparatus 1509, or installed from the storage apparatus 1508, or installed from the ROM 1502. When the computer program is executed by the processing apparatus 1501, above functions defined in the methods of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus or device. In the present disclosure, the computer-readable signal medium may include a data signal propagated in a baseband or as a part of a carrier wave, and computer-readable program codes are carried in the data signal. The data signal propagated in this manner may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus or device. The program codes contained in the computer-readable medium may be transmitted by any suitable medium, including but not limited to: wire, optical cable, radio frequency (RF), etc., or any suitable combination thereof.

In some implementations, communication may be performed with any currently known or future developed network protocol such as the HyperText Transfer Protocol (HTTP), and may be interconnected with digital data communication (for example, communication network) of any form or medium. Examples of communication networks include a local area network (“LAN”), a wide area network (“WAN”), an inter-network (for example, the Internet), and a peer-to-peer network (for example, an ad hoc peer-to-peer network), and any currently known or future developed network.

The above computer-readable medium may be included in the above electronic device, or may exist alone without being assembled into the electronic device.

The above computer-readable medium carries one or more programs, and when the one or more programs are executed by the electronic device, the electronic device is caused to: display a video editing interface, where a target text is displayed in the video editing interface; display a storyboard list based on the target text in response to a storyboard generation operation on the video editing interface, where the storyboard list includes a plurality of storyboard cards, a storyboard picture and a storyboard subtitle are displayed in each of the storyboard cards, and the storyboard subtitle is obtained by splitting the target text; and generate a video based on the storyboard list in response to a video generation operation on the video editing interface.

The computer program codes for performing the operations of the present disclosure may be written in one or more programming languages or a combination thereof. The above programming languages include, but are not limited to, object-oriented programming languages such as Java, Smalltalk and C++, and also include conventional procedural programming languages such as “C” programming language or similar programming languages. The program codes may be executed entirely on a user's computer, partly on a user's computer, as a stand-alone software package, partly on a user's computer and partly on a remote computer, or entirely on a remote computer or a server. In the case of involving the remote computer, the remote computer may be connected to the user's computer through any kind of network, including a local area network (LAN) or a wide area network (WAN), or may be connected to an external computer (for example, connected via the Internet using an Internet service provider).

The flowcharts and block diagrams in the drawings illustrate the architecture, functions and operations of possible implementations of the system, method and computer program product according to various embodiments of the present disclosure. In this regard, each block in the flowcharts or block diagrams may represent a module, a program segment, or a portion of codes, and the module, the program segment, or the portion of codes contains one or more executable instructions for realizing specified logical functions. It should also be noted that, in some alternative implementations, the functions marked in the blocks may also occur in a different order from those marked in the drawings. For example, two blocks shown in succession may, in fact, be executed substantially in parallel, or may sometimes be executed in a reverse order, depending on the functions involved. It should also be noted that, each block in the block diagrams and/or flowcharts and the combination of blocks in the block diagrams and/or flowcharts may be implemented by a dedicated hardware-based system that performs the specified functions or operations, or may be implemented by a combination of dedicated hardware and computer instructions.

The modules involved in the embodiments of the present disclosure may be implemented in software or hardware. The name of the module does not constitute a limitation on the module itself under certain circumstances.

The functions described above herein may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept. For example, the technical solutions formed by replacing the above features with the technical features having similar functions disclosed in the present disclosure (but not limited to).

In addition, although operations are depicted in a particular order, this should not be understood as requiring that such operations are performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims. Regarding the apparatus in above embodiments, the specific manner in which the respective modules perform operations has been described in detail in the embodiments related to the method, and will not be described in detail here.

1. A video generation method, comprising:
displaying a video editing interface, wherein a target text is displayed in the video editing interface;
displaying a storyboard list based on the target text in response to a storyboard generation operation on the video editing interface, wherein the storyboard list comprises a plurality of storyboard cards, a storyboard picture and a storyboard subtitle are displayed in each of the storyboard cards, and the storyboard subtitle is obtained by splitting the target text; and
generating a video based on the storyboard list in response to a video generation operation on the video editing interface.

2. The video generation method according to claim 1, wherein displaying the storyboard list based on the target text in response to the storyboard generation operation on the video editing interface comprises:
displaying the storyboard list in a first display region of the video editing interface based on the target text in response to the storyboard generation operation on the video editing interface; and
wherein the method further comprises:
enlarging and displaying a storyboard picture corresponding to a first storyboard card in the storyboard list in a second display region of the video editing interface and displaying the storyboard subtitle on the storyboard picture in response to a trigger operation on the first storyboard card.

3. The video generation method according to claim 2, further comprising:
displaying a configuration panel for configuring a storyboard picture in a third display region of the video editing interface in response to a trigger operation on a first storyboard card in the storyboard list, wherein the first display region, the second display region and the third display region are arranged side by side or in parallel;
determining a generated target picture in response to a picture generation operation on the configuration panel, and displaying the target picture at a first preset position around the storyboard picture in the second display region; and
updating and displaying the storyboard picture in the first storyboard card in the first display region as the target picture and updating and displaying the storyboard picture displayed in the second display region as the target picture in response to a selection operation on the target picture.

4. The video generation method according to claim 1, wherein the video editing interface is further displayed with at least one of a group consisting of a first control and a second control, the first control is used to trigger an overall preview of all storyboards in the storyboard list, and the second control is used to turn on a dynamic picture effect of a storyboard picture, and the method further comprises at least one of:
displaying preview effects of storyboards in the storyboard list in sequence according to a storyboard sequence in the storyboard list in response to a trigger operation on the first control; and
enlarging and displaying a storyboard picture corresponding to a first storyboard card in the storyboard list in the video editing interface in response to a trigger operation on the first storyboard card in the storyboard list, and displaying a dynamic picture effect of the storyboard picture corresponding to the first storyboard card in response to a trigger operation on the second control.

5. The video generation method according to claim 1, further comprising:
displaying at least one of a third control and a fourth control in the video editing interface, wherein the third control is used to add content before all storyboards, and the fourth control is used to add content after all storyboards;
positioning and displaying the storyboard list to a first storyboard card and simultaneously displaying a first configuration interface for configuring the content to be added in response to a trigger operation on the third control, and displaying a new storyboard card before the first storyboard card in the storyboard list in response to a content configuration operation on the first configuration interface; and/or
positioning and displaying the storyboard list to a last storyboard card and simultaneously displaying a second configuration interface for configuring the content to be added in response to a trigger operation on the fourth control, and displaying a new storyboard card after the last storyboard card in response to a content configuration operation on the second configuration interface.

6. The video generation method according to claim 1, wherein the second storyboard card in the storyboard list is associated with a plurality of storyboard pictures, and a first storyboard picture selected by a user from the plurality of storyboard pictures is displayed in the second storyboard card, and generating the video based on the storyboard list in response to the video generation operation on the video editing interface comprises:
generating a first video based on the first storyboard picture and a storyboard picture associated with a third storyboard card and generating a second video based on a second storyboard picture and a storyboard picture associated with the third storyboard card respectively in response to the video generation operation on the video editing interface, wherein the second storyboard picture is a storyboard picture in the plurality of storyboard pictures except the first storyboard picture, and the third storyboard card is a storyboard card in the storyboard list except the second storyboard card.

7. The video generation method according to claim 6, wherein the first video is displayed with a first identification, and the second video is displayed with a second identification, wherein the first identification is used to indicate that the first video is generated by the first storyboard picture selected by the user, and the second identification is used to indicate video feature information of the second video.

8. The video generation method according to claim 6, further comprising:
enlarging and displaying the first storyboard picture in the video editing interface and displaying plurality of storyboard pictures associated with the second storyboard card at a preset position around the first storyboard picture that is enlargedly displayed in response to a trigger operation on the second storyboard card in the storyboard list; and
updating the first storyboard picture displayed in the second storyboard card as a third storyboard picture and updating the first storyboard picture that is enlargedly displayed as a third storyboard picture that is enlargedly displayed in response to a selection operation on the third storyboard picture in the plurality of storyboard pictures.

9. A non-transitory computer-readable storage medium, on which a computer program is stored, wherein the program, when executed by a processing apparatus, cause the processing apparatus to implement a video generation method, and the method comprises:
displaying a video editing interface, wherein a target text is displayed in the video editing interface;
displaying a storyboard list based on the target text in response to a storyboard generation operation on the video editing interface, wherein the storyboard list comprises a plurality of storyboard cards, a storyboard picture and a storyboard subtitle are displayed in each of the storyboard cards, and the storyboard subtitle is obtained by splitting the target text; and
generating a video based on the storyboard list in response to a video generation operation on the video editing interface.

10. The storage medium according to claim 9, wherein displaying the storyboard list based on the target text in response to the storyboard generation operation on the video editing interface comprises:
displaying the storyboard list in a first display region of the video editing interface based on the target text in response to the storyboard generation operation on the video editing interface; and
wherein the method further comprises:
enlarging and displaying a storyboard picture corresponding to a first storyboard card in the storyboard list in a second display region of the video editing interface and displaying the storyboard subtitle on the storyboard picture in response to a trigger operation on the first storyboard card.

11. The storage medium according to claim 10, wherein the video generation method further comprises:
displaying a configuration panel for configuring a storyboard picture in a third display region of the video editing interface in response to a trigger operation on a first storyboard card in the storyboard list, wherein the first display region, the second display region and the third display region are arranged side by side or in parallel;
determining a generated target picture in response to a picture generation operation on the configuration panel, and displaying the target picture at a first preset position around the storyboard picture in the second display region; and
updating and displaying the storyboard picture in the first storyboard card in the first display region as the target picture and updating and displaying the storyboard picture displayed in the second display region as the target picture in response to a selection operation on the target picture.

12. The storage medium according to claim 9, wherein the video editing interface is further displayed with at least one of a group consisting of a first control and a second control, the first control is used to trigger an overall preview of all storyboards in the storyboard list, and the second control is used to turn on a dynamic picture effect of a storyboard picture, and the method further comprises at least one of:
displaying preview effects of storyboards in the storyboard list in sequence according to a storyboard sequence in the storyboard list in response to a trigger operation on the first control; and
enlarging and displaying a storyboard picture corresponding to a first storyboard card in the storyboard list in the video editing interface in response to a trigger operation on the first storyboard card in the storyboard list, and displaying a dynamic picture effect of the storyboard picture corresponding to the first storyboard card in response to a trigger operation on the second control.

13. The storage medium according to claim 9, wherein the method further comprises:
displaying at least one of a third control and a fourth control in the video editing interface, wherein the third control is used to add content before all storyboards, and the fourth control is used to add content after all storyboards;
positioning and displaying the storyboard list to a first storyboard card and simultaneously displaying a first configuration interface for configuring the content to be added in response to a trigger operation on the third control, and displaying a new storyboard card before the first storyboard card in the storyboard list in response to a content configuration operation on the first configuration interface; and/or
positioning and displaying the storyboard list to a last storyboard card and simultaneously displaying a second configuration interface for configuring the content to be added in response to a trigger operation on the fourth control, and displaying a new storyboard card after the last storyboard card in response to a content configuration operation on the second configuration interface.

14. The storage medium according to claim 9, wherein the second storyboard card in the storyboard list is associated with a plurality of storyboard pictures, and a first storyboard picture selected by a user from the plurality of storyboard pictures is displayed in the second storyboard card, and generating the video based on the storyboard list in response to the video generation operation on the video editing interface comprises:
generating a first video based on the first storyboard picture and a storyboard picture associated with a third storyboard card and generating a second video based on a second storyboard picture and a storyboard picture associated with the third storyboard card respectively in response to the video generation operation on the video editing interface, wherein the second storyboard picture is a storyboard picture in the plurality of storyboard pictures except the first storyboard picture, and the third storyboard card is a storyboard card in the storyboard list except the second storyboard card.

15. The storage medium according to claim 14, wherein the first video is displayed with a first identification, and the second video is displayed with a second identification, wherein the first identification is used to indicate that the first video is generated by the first storyboard picture selected by the user, and the second identification is used to indicate video feature information of the second video.

16. The storage medium according to claim 14, wherein the method further comprises:
enlarging and displaying the first storyboard picture in the video editing interface and displaying plurality of storyboard pictures associated with the second storyboard card at a preset position around the first storyboard picture that is enlargedly displayed in response to a trigger operation on the second storyboard card in the storyboard list; and
updating the first storyboard picture displayed in the second storyboard card as a third storyboard picture and updating the first storyboard picture that is enlargedly displayed as a third storyboard picture that is enlargedly displayed in response to a selection operation on the third storyboard picture in the plurality of storyboard pictures.

17. An electronic device, comprising:
a storage apparatus, on which a computer program is stored; and
a processing apparatus, configured to execute the computer program in the storage apparatus to implement the steps of a video generation method, and the method comprises:
displaying a video editing interface, wherein a target text is displayed in the video editing interface;
displaying a storyboard list based on the target text in response to a storyboard generation operation on the video editing interface, wherein the storyboard list comprises a plurality of storyboard cards, a storyboard picture and a storyboard subtitle are displayed in each of the storyboard cards, and the storyboard subtitle is obtained by splitting the target text; and
generating a video based on the storyboard list in response to a video generation operation on the video editing interface.

18. The electronic device according to claim 17, wherein displaying the storyboard list based on the target text in response to the storyboard generation operation on the video editing interface comprises:
displaying the storyboard list in a first display region of the video editing interface based on the target text in response to the storyboard generation operation on the video editing interface; and
the method further comprises:
enlarging and displaying a storyboard picture corresponding to a first storyboard card in the storyboard list in a second display region of the video editing interface and displaying the storyboard subtitle on the storyboard picture in response to a trigger operation on the first storyboard card.

19. The electronic device according to claim 18, wherein the video generation method further comprises:
displaying a configuration panel for configuring a storyboard picture in a third display region of the video editing interface in response to a trigger operation on a first storyboard card in the storyboard list, wherein the first display region, the second display region and the third display region are arranged side by side or in parallel;
determining a generated target picture in response to a picture generation operation on the configuration panel, and displaying the target picture at a first preset position around the storyboard picture in the second display region; and
updating and displaying the storyboard picture in the first storyboard card in the first display region as the target picture and updating and displaying the storyboard picture displayed in the second display region as the target picture in response to a selection operation on the target picture.

20. The electronic device according to claim 17, wherein the video editing interface is further displayed with at least one of a group consisting of a first control and a second control, the first control is used to trigger an overall preview of all storyboards in the storyboard list, and the second control is used to turn on a dynamic picture effect of a storyboard picture, and the method further comprises at least one of a group consisting of:
displaying preview effects of storyboards in the storyboard list in sequence according to a storyboard sequence in the storyboard list in response to a trigger operation on the first control; and
enlarging and displaying a storyboard picture corresponding to a first storyboard card in the storyboard list in the video editing interface in response to a trigger operation on the first storyboard card in the storyboard list, and displaying a dynamic picture effect of the storyboard picture corresponding to the first storyboard card in response to a trigger operation on the second control.
